(19) United States
(12) Patent Application Publication
(10) Pub. No.: US 2022/0036380 A1
(43) Pub. Date: Feb. 3, 2022

(54) CUSTOMER INFORMATION REGISTRATION APPARATUS

(71) Applicant: NEC Corporation, Minato-ku, Tokyo (JP)

(72) Inventor: Makoto IGARASHI, Tokyo (JP)

(73) Assignee: NEC Corporation, Minato-ku, Tokyo (JP)

(21) Appl. No.: 17/278,783

(22) PCT Filed: Aug. 28, 2019
(86) PCT No.: PCT/JP2019/033747

§ 371 Date: Mar. 23, 2021

(30) Foreign Application Priority Data
Sep. 26, 2018 (JP) 2018-180214

(51) Int. Cl. G06Q 30/02; G06K 9/00

(52) U.S. Cl. CPC G06Q 30/0201; G06K 2009/00953; G06K 9/00221; G06K 9/00926

(57) ABSTRACT

A customer information registration apparatus includes: a face data acquisition unit configured to acquire face data of a customer based on image data acquired by a camera of a shop, and temporarily store the acquired face data of the customer into a storage unit; an analysis unit configured to acquire ancillary information, which is information that does not identify an individual customer in a shooting site of the camera; a rejection information acquisition unit configured to acquire rejection information indicating that registration of the face data of the customer is not wanted; and a deletion unit configured to, in response to the rejection information acquired by the rejection information acquisition unit, delete the face data of the customer temporarily stored in the storage unit, and also delete information originating from the customer that is a deletion target from the ancillary information and update the ancillary information.

### TECHNICAL FIELD

The present invention relates to a customer information registration apparatus, a customer information registration method, a recording medium, a camera, and a customer information registration system.

### BACKGROUND ART

For purposes such as marketing, information of a feature value calculated based on a face image of a customer may be registered and managed.

One of such techniques is described in, for example, Patent Document 1. In Patent Document 1, a usage control system that includes a feature value extraction unit, an agreement sign extraction unit, a determination unit, and a control unit is described. According to Patent Document 1, the feature value extraction unit extracts a biological feature value from biological information acquired by a terminal device. The agreement sign extraction unit also extracts, from the biological information, an agreement sign, which is information acquired as identification information instructing deletion of person information together with the biological information of a deletion target person and is information other than the identification information of the person. The determination unit determines whether or not the agreement sign is extracted. Then, in a case where the determination unit determines that the agreement sign is extracted, the control unit performs control to make person information matching the extracted biological feature value unavailable on a storage medium for storing biological feature values as person information.
Patent Document 1: Japanese Translation of PCT International Application Publication WO2016/051790

In the case of the technique described in Patent Document 1, control to make person information matching an extracted biological feature value unavailable is performed in accordance with an extracted agreement sign. Therefore, in the case of the technique described in Patent Document 1, there is a problem that information which does not identify an individual person (for example, information indicating only the attribute of a person such as the date when a 30-year-old man visited, and statistical data), or the like, remains as it is.

There is a fear that the information as mentioned above indirectly allows identification of a person. Therefore, a person who does not want person information to be used may not want the information which does not identify an individual as mentioned above to be registered, either. However, as stated above, the technique described in Patent Document 1 merely enables control to make person information unavailable, and does not enable control of information which does not identify an individual. Thus, there has been a problem that it is difficult to more strictly respond to an individual's desire that he/she does not want information relating to the individual to be used.

### SUMMARY

Accordingly, an object of the present invention is to provide a customer information registration apparatus, a customer information registration method, a recording medium, a camera, and a customer information registration system which can more strictly respond to an individual's desire that he/she does not want information relating the individual to be used.

In order to achieve the object, a customer information registration apparatus as an aspect of the present invention includes: a face data acquisition unit configured to acquire face data of a customer based on image data acquired by a camera of a shop, and temporarily store the acquired face data of the customer into a storage unit; an analysis unit configured to acquire ancillary information, which is information that does not identify an individual customer in a shooting site of the camera; a rejection information acquisition unit configured to acquire rejection information indicating that registration of the face data of the customer is not wanted; and a deletion unit configured to, in response to the rejection information acquired by the rejection information acquisition unit, delete the face data of the customer temporarily stored in the storage unit, and also delete information originating from the customer that is a deletion target from the ancillary information and update the ancillary information.

Further, a customer information registration method as another aspect of the present invention is a customer information registration method executed by a customer information registration apparatus including a storage unit. The customer information registration method includes: acquiring face data of a customer based on image data acquired by a camera of a shop, and temporarily store the acquired face data of the customer into the storage unit; acquiring ancillary information, which is information that does not identify an individual customer in a shooting site of the camera; acquiring rejection information indicating that registration of the face data of the customer is not wanted; and in response to the acquired rejection information, deleting the face data of the customer temporarily stored in the storage unit, and also deleting information originating from the customer that is a deletion target from the ancillary information and updating the ancillary information.

Further, a recording medium as another aspect of the present invention is a non-transitory computer-readable recording medium having a program recorded thereon. The program includes instructions for causing a customer information registration apparatus including a storage unit to realize: a face data acquisition unit configured to acquire face data of a customer based on image data acquired by a camera of a shop, and temporarily store the acquired face data of the customer into a storage unit; an analysis unit configured to acquire ancillary information, which is information that does not identify an individual customer in a shooting site of the camera; a rejection information acquisition unit configured to acquire rejection information indicating that registration of the face data of the customer is not wanted; and a deletion unit configured to, in response to the rejection information acquired by the rejection information acquisition unit, delete the face data of the customer temporarily stored in the storage unit, and also delete information originating from the customer that is a deletion target from the ancillary information and update the ancillary information.

Further, a camera as another aspect of the present invention includes: a face data acquisition unit configured to acquire face data of a customer based on acquired image data, and temporarily store the acquired face data of the customer into a storage unit; an analysis unit configured to acquire ancillary information, which is information that does not identify an individual customer in a shooting site; a rejection information acquisition unit configured to acquire rejection information indicating that registration of the face data of the customer is not wanted; and a deletion unit configured to, in response to the rejection information acquired by the rejection information acquisition unit, delete the face data of the customer temporarily stored in the storage unit, and also delete information originating from the customer that is a deletion target from the ancillary information and update the ancillary information.

Further, a customer information registration system as another aspect of the present invention is a customer information registration system including a customer information registration apparatus and a camera. The customer information registration apparatus includes: a face data acquisition unit configured to acquire face data of a customer based on image data acquired by a camera of a shop, and temporarily store the acquired face data of the customer into a storage unit; an analysis unit configured to acquire ancillary information, which is information that does not identify an individual customer in a shooting site of the camera; a rejection information acquisition unit configured to acquire rejection information indicating that registration of the face data of the customer is not wanted; and a deletion unit configured to, in response to the rejection information acquired by the rejection information acquisition unit, delete the face data of the customer temporarily stored in the storage unit, and also delete information originating from the customer that is a deletion target from the ancillary information and update the ancillary information.

With the configurations as described above, the present invention can provide a customer information registration apparatus, a customer information registration method, a recording medium, a camera, and a customer information registration system which can more strictly respond to an individual's desire that he/she does not want information relating to the individual to be used.

### BRIEF DESCRIPTION OF DRAWINGS

FIG. 1 is a view showing an example of an entire configuration of a customer information registration system in a first example embodiment of the present invention;

FIG. 2 is a block diagram showing an example of a configuration of a customer information registration apparatus shown in FIG. 1;

FIG. 3 is a view showing an example of temporary customer information shown in FIG. 2;

FIG. 4 is a view showing an example of ancillary information shown in FIG. 2;

FIG. 5 is a view showing an example of optout information shown in FIG. 2;

FIG. 6 is a view showing an example of customer information shown in FIG. 2;

FIG. 7 is a view showing another example of customer information shown in FIG. 2;

FIG. 8 is a view showing an example of an output by an output unit;

FIG. 9 is a block diagram showing an example of a configuration of a cash register shown in FIG. 1;

FIG. 10 is a block diagram showing an example of a configuration of a customer terminal shown in FIG. 1;

FIG. 11 is a flowchart showing an example of an operation of the customer information registration apparatus;

FIG. 12 is a block diagram showing an example of a configuration of a customer information registration apparatus in a second example embodiment of the present invention; and

FIG. 13 is a block diagram showing an example of a configuration of a customer information registration system in the second example embodiment of the present invention.

### EXAMPLE EMBODIMENTS

### First Example Embodiment

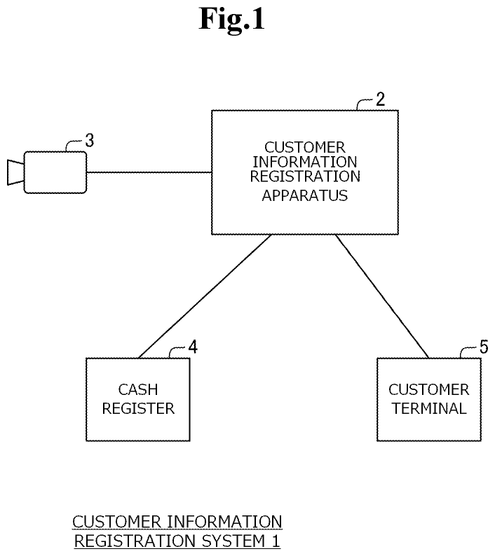

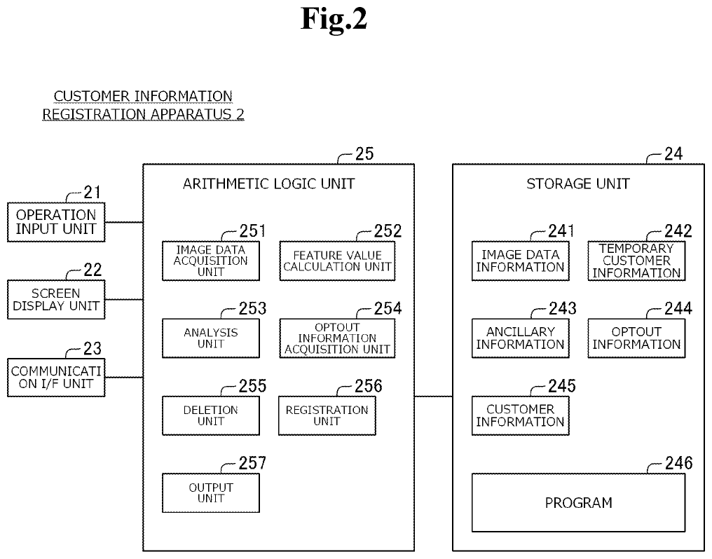

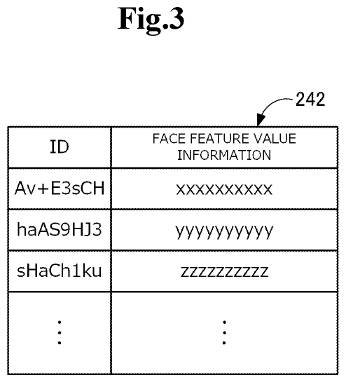

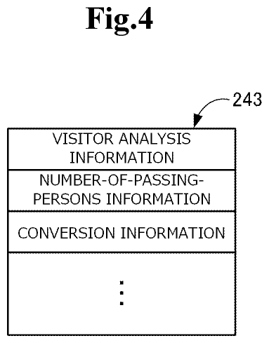

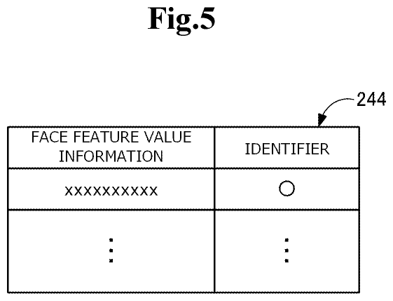

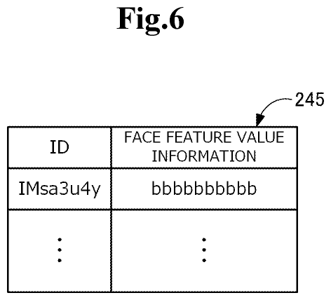

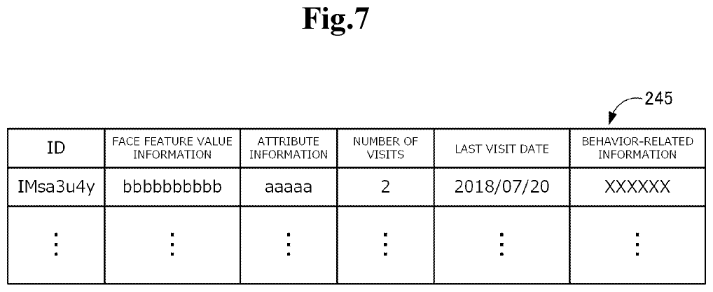

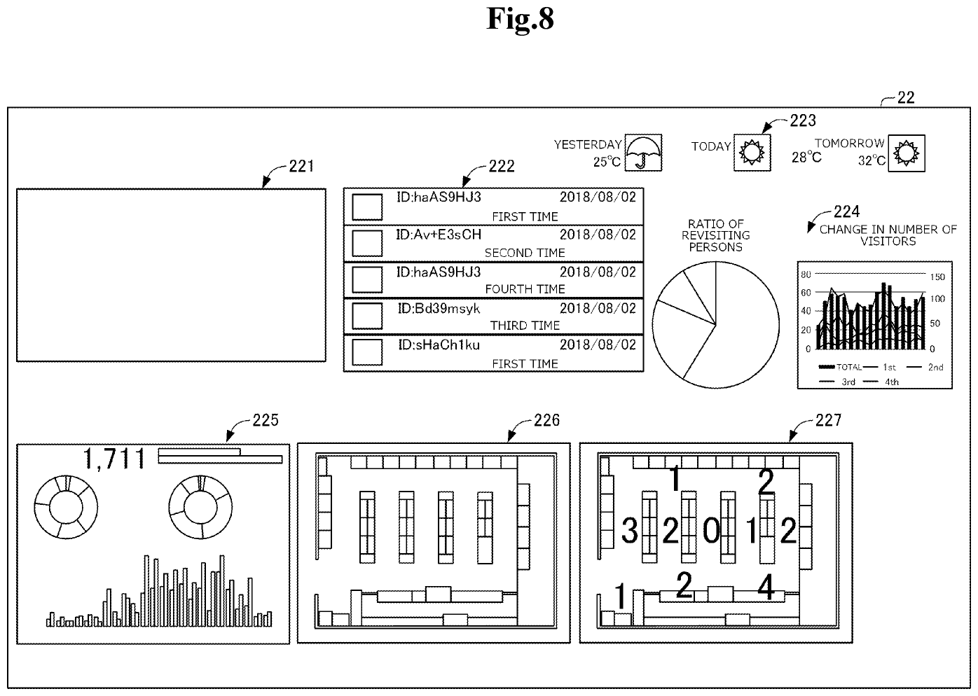

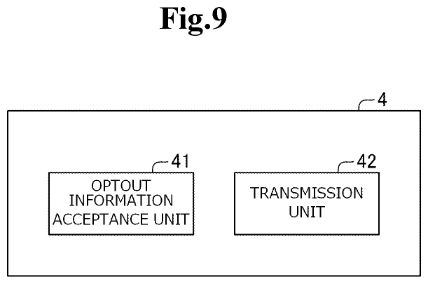

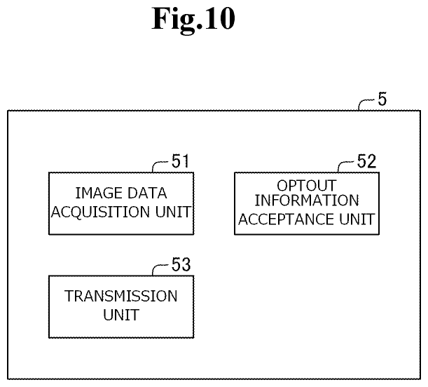

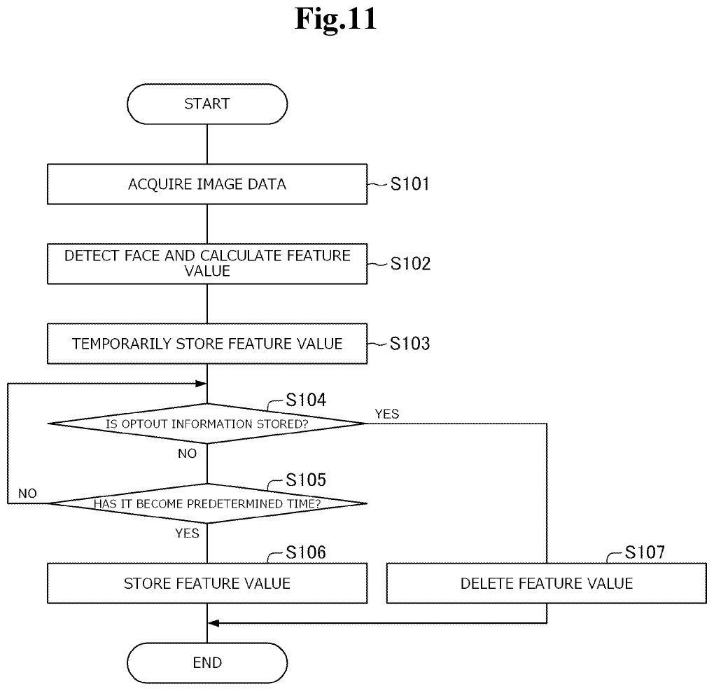

A first example embodiment of the present invention will be described with reference to FIGS. 1 to 11. FIG. 1 is a view showing an example of an entire configuration of a customer information registration system 1. FIG. 2 is a block diagram showing an example of a configuration of a customer information registration apparatus 2. FIG. 3 is a view showing an example of temporary customer information 242. FIG. 4 is a view showing an example of ancillary information 243. FIG. 5 is a view showing an example of optout information 244. FIGS. 6 and 7 are views showing examples of customer information 245. FIG. 8 is a view showing an example of an output by an output unit. FIG. 9 is a block diagram showing an example of a configuration of a cash register 4. FIG. 10 is a block diagram showing an example of a configuration of a customer terminal 5. FIG. 11 is a flowchart showing an example of an operation of the customer information registration apparatus 2.

In the first example embodiment of the present invention, the customer information registration system 1 having the customer information registration apparatus 2 will be described. The customer information registration apparatus 2 stores face data of a customer for the purpose of utilizing for customer analysis such as repeater detection. As will be described later, the customer information registration apparatus 2 in this example embodiment acquires, from a customer, optout information indicating that he/she does not want face data to be registered. Then, the customer information registration apparatus 2 deletes temporarily stored face data. Moreover, the customer information registration apparatus 2 also deletes information originating from a customer who wants to be deleted in ancillary information, which is statistical information that does not identify an individual person. Herein, face data refers to a feature value calculated from a face image or the face image. In the following description, a case of employing the feature value as face data will be described.

FIG. 1 shows an example of an entire configuration of the customer information registration system 1. Referring to FIG. 1, the customer information registration system 1 has, for example, the customer information registration apparatus 2, a camera 3, the cash register 4, and the customer terminal 5.

As shown in FIG. 1, the customer information registration apparatus 2 and the camera 3 are connected so as to be able to communicate with each other. The customer information registration apparatus 2 and the cash register 4 are also connected so as to be able to communicate with each other. The customer information registration apparatus 2 and the customer terminal 5 are also connected so as to be able to communicate with each other.

The configuration of the customer information registration system 1 is not limited to the case shown in FIG. 1. For example, the numbers of the cameras 3, the cash registers 4, and the customer terminals 5 may be one, or may be two or more. Moreover, for example, the customer information registration system 1 may have every kind of sensor such as a weight sensor installed on a product shelf or at the entrance of a shop, a RFID (radio frequency identifier) reader, and so on. Moreover, for example, the customer information registration system 1 may have no cash register 4 or no customer terminal 5.

The customer information registration apparatus 2 is an information processing apparatus in which a feature value is stored. FIG. 2 shows an example of a configuration of the customer information registration apparatus 2. Referring to FIG. 2, the customer information registration apparatus 2 has, as major components, an operation input unit 21, a screen display unit 22, a communication I/F unit 23, a storage unit 24, and an arithmetic logic unit 25.

The operation input unit 21 is formed by operation input devices such as a keyboard and a mouse. The operation input unit 21 detects an operation by an operator and outputs to the arithmetic logic unit 25.

The screen display unit 22 is formed by a screen display device such as an LCD (Liquid Crystal Display). The screen display unit 22 displays every kind of information on a screen in response to an instruction from the arithmetic logic unit 25. For example, the screen display unit 22 displays, on the screen, image data information 241, the temporary customer information 242, the ancillary information 243, the optout information 244, the customer information 245, and so on, in response to an instruction from the arithmetic logic unit 25.

The communication I/F unit 23 is formed by, for example, a data communication circuit. The communication I/F unit 23 performs data communication with every kind of device connected via a communication line. For example, the customer information registration apparatus 2 performs communication with the camera 3, the cash register 4, the customer terminal 5, and an external device such as a sensor via the communication I/F unit 23.

The storage unit 24 is a memory unit. The storage unit 24 includes a hard disk, a memory (for example, a volatile memory), and so on. In the storage unit 24, processing information necessary for every kind of processing in the arithmetic logic unit 25 and a program 246 are stored. The program 246 is loaded to and executed by the arithmetic logic unit 25 and thereby realizes every kind of processing unit. The program 246 is loaded in advance from an external device or a recording medium via a data input/output function such as the communication I/F unit 23 and stored in the storage unit 24. Major information stored in the storage unit 24 are the image data information 241, the temporary customer information 242, the ancillary information 243, the optout information 244, and the customer information 245.

The image data information 241 is image data acquired from the camera 3 via the communication I/F unit 23. The image data information 241 is, for example, used by a feature value calculation unit 252 and an analysis unit 253.

The temporary customer information 242 indicates information relating to a customer visiting the inside of a shooting area or a monitored area of the camera 3, such as the inside of a shop. The temporary customer information 242 is temporarily stored in the storage unit 24. For example, the temporary customer information 242 is divided into information deleted based on the optout information 244 acquired by an optout information acquisition unit 254 and information stored into the storage unit 24 as the customer information 245 by a registration unit 256. The temporary customer information 242 is stored into a memory unit for temporarily storing data such as a volatile memory of the storage unit 24, for example.

The temporary customer information 242 includes face feature value information indicating a feature value calculated from a face image of a customer. FIG. 3 shows an example of the temporary customer information 242. Referring to FIG. 3, in the temporary customer information 242, for example, an ID and face feature value information are associated with each other. For example, in the first row of FIG. 3, an ID “Av+E3sCH” and face feature value information “xxxxxxxxxx” are associated with each other. Herein, an ID is identification information for identifying a customer. An ID is automatically assigned by the feature value calculation unit 252 or the like when new face feature value information is stored as the temporary customer information 242 into the storage unit 24, for example. Face feature value information is information indicating a feature value of a face image. Face feature value information is calculated based on a face image (the image data information 241) by the feature value calculation unit 252.

The temporary customer information 242 may include information other than illustrated above. For example, the temporary customer information 242 can include attribute information indicating the age, gender and so on of a customer determined from a face image, behavior-related information (behavior information) that is information relating to the behavior of a customer in a shooting area or a monitored area of the camera 3 such as the inside of the shop. Behavior-related information can include information indicating the number of cameras having captured the corresponding customer in one visit, the stay time of the customer in the entire shop or in each area when the inside of the shop is divided into a plurality of areas in advance, the presence or absence of detection of reaching for a product, the presence or absence of purchase of a product, the flow line of the customer, the line of sight of the customer, and the like.

The ancillary information 243 indicates information (for example, statistical information) which does not identify an individual customer in a shooting site of the camera 3, such as the inside of a shop. The ancillary information 243 is generated by the analysis unit 253 based on the image data information 241, for example.

FIG. 4 shows an example of information which can be included as the ancillary information 243. Referring to FIG. 4, the ancillary information 243 can include, for example, every kind of statistical information such as visitor analysis information, number-of-passing-persons information, and conversion information. Visitor analysis information is information indicating the number of customers for each predetermined attribute, such as information obtained by counting the number of customers for each number of visits, information obtained by counting the number of customers for each number of visits before purchase, and information obtained by counting the number of customers for each age and gender. Number-of-passing-persons information is information indicating the number of customers passing through a predetermine site within a given time for each predetermined site. Conversion information is information indicating which area of the shop customers stay in for a long time, and can be used at the time of grasping the stay statuses of customers.

The ancillary information 243 may include information other than the illustrated above. For example, the ancillary information 243 may include statistical information which does not identify an individual customer other than the illustrated above, such as heat map information and information indicating the number of customers for each weather.

The optout information 244 is information indicating that a customer does not want a feature value to be registered, and instructs deletion of a feature value stored in the storage unit 24. The optout information 244 is acquired from, for example, the cash register 4 or the customer terminal 5 via the communication I/F unit 23. The optout information 244 may be acquired from the image data information 241, or the like.

FIG. 5 shows an example of the optout information 244. Referring to FIG. 5, for example, face feature value information and an identifier indicating an instruction of deletion of a feature value are associated with the optout information 244. For example, in the first row of FIG. 5, face feature value information “xxxxxxxxxx” and an identifier “o” are associated with each other. This represents that a customer with the face feature value information “xxxxxxxxxx” wants deletion of the feature value (that is, does not want registration of the feature value).

It is desirable that information included in the optout information 244 is deleted after a lapse of a predetermined period such as one day, one week or one month after registration. By periodically deleting the optout information 244, it is possible to prevent personal information from remaining as the optout information 244.

The customer information 245 indicates information relating to a customer visiting the inside of a shooting area or a monitored area of the camera 3, such as the inside of the shop. For example, the customer information 245 is stored in the storage unit 24. The customer information 245 is stored in a memory unit such as a hard disk of the storage unit 24.

The customer information 245 includes at least face feature value information indicating a feature value calculated from a face image of a customer. FIG. 6 shows an example of the customer information 245. Referring to FIG. 6, in the customer information 245, for example, an ID and face feature value information are associated with each other. For example, in the first row of FIG. 6, an ID “IMsa3u4y” and face feature value information “bbbbbbbbbb” are associated with each other. Thus, the customer information 245 includes information according to information included by the temporary customer information 242.

As with the temporary customer information 242, the customer information 245 may include information other than illustrated above. For example, the customer information 245 can include attribute information, behavior-related information (behavior information), and so on. Moreover, the customer information 245 may include past visit information indicating the number of visits and a last visit date.

For example, FIG. 7 shows another example of the customer information 245. Referring to FIG. 7, in the other customer information 245, for example, an ID, face feature value information, attribute information, the number of visits, a last visit date, and behavior-related information are associated with each other. For example, in the first row of FIG. 7, an ID “IMsa3u4y”, face feature value information “bbbbbbbbbb”, attribute information “aaaaa”, the number of visits “2”, a last visit date “2018/07/20”, and behavior-related information “XXXXXX” are associated with each other. The number of visits indicates the number of times that a customer visited until the last time (or including the present time), and a last visit date indicates the date when a customer visited last time. Visit information such as the number of visits and a last visit date are updated by the registration unit 256 or the like, for example.

The arithmetic logic unit 25 has a microprocessor such as a MPU and a peripheral circuit thereof, loads the program 246 from the storage unit 24 and executes the program 246, and thereby makes the abovementioned hardware and the program 246 cooperate with each other to realize various processing units. Major processing units realized by the arithmetic logic unit 25 are, for example, an image data acquisition unit 251, the feature value calculation unit 252, the analysis unit 253, the optout information acquisition unit 254, a deletion unit 255, the registration unit 256, and an output unit 257.

The image data acquisition unit 251 acquires image data from the camera 3 via the communication I/F unit 23. Then, the image data acquisition unit 251 stores the acquired image data into the storage unit 24 as the image data information 241.

In a case where the customer information registration system 1 has a plurality of cameras 3, the image data acquisition unit 251 acquires image data from each of the plurality of cameras 3. In such a case, for example, the image data acquisition unit 251 can associate identification information of the camera 3 with the image data and store the associated information into the storage unit 24. In other words, the image data acquisition unit 251 can store image data into the storage unit 24 in a way that it can be determined which camera 3 has acquired the image data.

The feature value calculation unit 252 (a face data acquisition unit) calculates the feature value of a face image. For example, the feature value calculation unit 252 extracts a face image (a face region) that is a region indicating the face of a customer from the image data information 241. Then, the feature value calculation unit 252 calculates the feature value of the extracted face image. After that, the feature value calculation unit 252 associates face feature value information indicating the calculated feature value with any ID that differs for each feature value, and stores into the storage unit 24 as the temporary customer information 242.

In this example embodiment, a process when the feature value calculation unit 252 calculates the feature value of a face image is not limited specifically. The feature value calculation unit 252 can calculate the feature value of a face image by a known method; for example, calculate the feature value based on the position of a facial feature point such as eye, nose, or edge of mouth detected from the face image. It is needless to say that the feature value calculation unit 252 may calculate the feature value by using another known method, for example, by using luminance information or using a value according to the relationship between local regions.

Further, there is a case where a feature value calculated by the feature value calculation unit 252 is included by the optout information 244. In this case, the feature value calculation unit 252 can be configured not to store the feature value included by the optout information 244 into the storage unit 24.

Further, as described above, in a case where the customer information registration apparatus 2 has a plurality of cameras 3, the image data acquisition unit 251 associates identification information of the camera 3 with the image data and stores the associated information into the storage unit 24, for example. Therefore, the feature value calculation unit 252 can associate the calculated feature value of the face image and the identification information of the corresponding camera 3, for example. In other words, the feature value calculation unit 252 can calculate the feature value in a way that it can be determined which camera 3 has acquired image data which the feature value has been calculated based on.

The analysis unit 253 analyzes image data indicated by the image data information 241 and a face image extracted from the image data, and thereby acquires statistical information that does not identify an individual customer, such as visitor analysis information, number-of-passing-persons information, and conversion information. Then, the analysis unit 253 stores the statistical information into the storage unit 24 as the ancillary information 243. Moreover, the analysis unit 253 analyzes image data indicated by the image data information 241 and a face image extracted from the image data, and can thereby acquire attribute information indicating the gender and age of a customer, and acquire behavior-related information (behavior information) such as the stay time in the shop or in each area, the presence or absence of reaching for a product, detection of the flow line, and detection of the line of sight of a customer.

Thus, the analysis unit 253 can acquire statistical information that does not identify an individual customer and also acquire attribute information and behavior-related information that are information for each customer based on the image data information 241. Moreover, the analysis unit 253 can acquire behavior-related information indicating whether a customer has purchased a product and what product a customer has purchased, for example, by associating the feature value of a face image with POS (Point of sale) information or the like acquired from the cash register 4. The processing by the analysis unit 253 may also be realized by using a known method such as estimation of gender and age based on a feature value. Therefore, a detailed description of the processing by the analysis unit 253 will be omitted.

The optout information acquisition unit 254 (a rejection information acquisition unit) acquires, from a customer, rejection information that is information indicating that the customer does not want a feature value to be registered (that is, information indicating that the customer wants a feature value stored in the storage unit 24 to be deleted). Then, the optout information acquisition unit 254 stores the acquired information into the storage unit 24 as the optout information 244.

For example, the optout information acquisition unit 254 acquires rejection information from an external device such as the cash register 4 or the customer terminal 5 via the communication I/F unit 23.

For example, the optout information acquisition unit 254 acquires information in which an identifier indicating an instruction to delete a feature value is associated with image data of the face of a customer from the customer terminal 5. Then, the optout information acquisition unit 254 instructs the feature value acquisition unit 252 to calculate a feature value from the image data of the face of the customer and thereby acquires the feature value from the feature value calculation unit 252. Then, the optout information acquisition unit 254 stores information in which the identifier is associated with the acquired feature value into the storage unit 24 as the optout information 244. In the case of acquiring the information in which the identifier is associated with the feature value of the customer from the customer terminal 5, the optout information acquisition unit 254 may store the acquired information as it is into the storage unit 24 as the optout information 244.

Further, for example, the optout information acquisition unit 254 acquires information indicating an identifier indicating an instruction to delete a feature value from the cash register 4. Moreover, the optout information acquisition unit 254 acquires image data of the face of a customer who has transmitted the identifier from the image data information 241 acquired by the camera 3 capturing the periphery of the cash register or the camera installed at the cash register 4. Then, the optout information acquisition unit 254 instructs the feature value calculation unit 252 to calculate a feature value from image data of the face of the customer and thereby acquires the feature value from the feature value calculation unit 252. Then, the optout information acquisition unit 254 stores information in which the identifier is associated with the acquired feature value into the storage unit 24 as the optout information 244.

Thus, upon acquiring rejection information that is information indicating that a customer does not want a feature value to be registered from the cash register 4 or the customer terminal 5, the optout information acquisition unit 254 stores the rejection information into the storage unit 24 as the optout information 244. The optout information acquisition unit 254 may acquire rejection information or the like based on the image data information 241, for example, in a case where it is detected that a customer is performing a given gesture from the image data information 241 acquired from the given camera 3 that is capturing the door of the shop or the periphery of the cash register, for example.

The deletion unit 255 deletes the temporary customer information 242 based on the optout information 244. For example, when the optout information 244 is registered, the deletion unit 255 refers to the optout information 244 and the temporary customer information 242. Then, the deletion unit 255 deletes information in which face feature value information indicating the same feature value as a feature value included by the optout information 244 is associated with an ID from the customer information 242. Since the deletion unit 255 thus deletes information based on the optout information 244, it is possible to prevent the feature value of a customer who does not want registration from being accumulated as the customer information 245.

Further, the deletion unit 255 updates the ancillary information 243 by deleting information originating from a customer indicated by a feature value included by the optout information 244 from the ancillary information 243 based on the optout information 244. For example, the deletion unit 255 can subtract 1 from the number of customers associated with a feature value indicating that registration is not wanted in the visitor analysis information included by the ancillary information 243. Moreover, the deletion unit 255 can subtract the count of customers who do not want registration from the number-of-passing-persons information. Moreover, the deletion unit 255 can update the conversion information so that a customer who does not want registration has not existed from the beginning. Thus, the deletion unit 255 can update the ancillary information 243 so that a customer who does not want registration has not existed. The deletion unit 255 may instruct the analysis unit 253 to reanalyze the image data information 241 assuming that a customer who does not want registration has not existed from the beginning, or the deletion unit 255 may be configured to directly update the ancillary information 243.

The deletion unit 255 performs the abovementioned deletion process every time the optout information 244 is stored by the optout information acquisition unit 254, for example. Alternatively, the deletion unit 255 may be configured to perform the abovementioned deletion process at a given timing (for example, immediately before registration by the registration unit 256) such as once a day in a batch, for example.

Thus, the deletion unit 255 deletes the temporary customer information 242 based on the optout information 244, and also updates the ancillary information 243. Consequently, it is possible to prevent the feature value of a customer who does not want registration of a feature value from being stored, and it is also possible to delete information originating from and relating to the customer from statistical information that does not identify an individual customer.

The registration unit 256 stores (transfers) information included by the temporary customer information 242 into the storage unit 24 as the customer information 245. For example, the registration unit 256 acquires information included by the temporary customer information 242 at predetermined intervals such as every predetermined time, every day, and every week, and stores the acquired information into the storage unit 24 as the customer information 245. Alternatively, the registration unit 256 acquires information included by the temporary customer information 242 at a predetermined time, and stores the acquired information into the storage unit 24 as the customer information 245. Moreover, the registration unit 256 deletes the information included by the temporary customer information 242.

Thus, the registration unit 256 stores information included by the temporary customer information 242 into the storage unit 24 as the customer information 245. Consequently, a feature value for which information indicating that a customer does not want registration of the feature value is not acquired from the customer in a predetermined interval or by a predetermined time is managed as the customer information 245.

The registration unit 256 may not be configured to store all the information included by the temporary customer information 242 into the storage unit 24 as the customer information 245 at predetermined intervals. For example, the registration unit 256 can be configured to transfer only information that a given time has passed since storage into the storage unit 24 as the temporary customer information 242.

Further, a case where a feature value to be registered by the registration unit 256 is already included by the customer information 245 is assumed. The registration unit 256 may be configured not to newly store the overlapping feature value as the customer information 245 in this case. Moreover, the registration unit 256 can be configured to, in a case where the customer information 245 includes visit information, update the visit information (for example, increase the number of visits by 1 and update the last visit date).

The output unit 257 instructs the screen display unit 22 or another external device to perform given output.

For example, the output unit 257 can instruct the screen display unit 22 or the like to output information relating to registration of the temporary customer information 242 by the feature value calculation unit 252, information relating to the optout information 244, information according to the deletion process by the deletion unit 255 and the registration process by the registration unit 256, and so on. For example, the output unit 257 can instruct to output information indicating that the temporary customer information 242 or the optout information 244 has been registered and statistical information such as the number of registrations. Moreover, the output unit 257 can instruct to output information indicating that the deletion process by the deletion unit 255 or the registration process by the registration unit 256 has been performed, information according to a feature value having been deleted or registered, and statistical information such as the number of deletions or the number of registrations. The instruction to output every kind of information by the output unit 257 may be output every time registration or processing of information is performed, or may be output at given intervals such as once a day at a given time, for example.

Further, for example, as shown in FIG. 8, the output unit 257 can instruct the screen display unit 22 to output the customer information 245 and so on together with image information 221 acquired by the camera 3, weather information 223, and so on. FIG. 8 shows an example of the display of the screen display unit 22 that is output as a result of the instruction by the output unit 257. Referring to FIG. 8, in response to the instruction from the output unit 257, for example, the image information 221, visiting customer information 222, the weather information 223, number-of-visits statistical information 224, attribute statistical information 225, conversion information 226, number-of-passing-persons information 227, and so on, can be displayed on the screen display unit 22.

Herein, the image information 221 indicates image data acquired from the camera 3 (the image data information 241). The visiting customer information 222 indicates information of customers visiting the shop at present. The vising customer information 222 can include at least part of the customer information 245. The weather information 223 indicates weather. In the case illustrated in FIG. 8, the weather information 223 indicates the weather for three days of yesterday, today, and tomorrow. The number-of-visits statistical information 224 indicates information indicating how many times each of the customers currently in the shop has visited the shop so far. The attribute statistical information 225 is information indicating the number of the customers by age and gender. The conversion information 226 is information indicating which area in the shop the customers stay in for a long time. The number-of-passing-persons information 227 is information indicating the number of passing persons within a given time. The number-of-visits statistical information 224, the attribute statistical information 225, the conversion information 226, and the number-of-passing-persons information 227 are associated with the ancillary information 243 acquired as a result of analysis by the analysis unit 253, for example.

Thus, the output unit 257 can instruct the screen display unit 22 to output the ancillary information 243, the customer information 245 and so on together with image data acquired by the image data acquisition unit 251. The output unit 257 may instruct the screen display unit 22 to output information other than the illustrated above.

The example of the configuration of the customer information registration apparatus 2 has been described above.

The camera 3 acquires image data. For example, the camera 3 is installed in advance at a given position in a shop, such as at the cash register 4, at the door of the shop and around a product shelf, to monitor the inside of the shop. The camera 3 may be a known surveillance camera, or the like.

The cash register 4 is an information processing apparatus equipped with a POS system, which manages sales information according to interactions with customers such as purchase of products. FIG. 9 shows an example of components specific to this example embodiment among components of the cash register 4. Referring to FIG. 9, the cash register 4 has, for example, an optout information acceptance unit 41 and a transmission unit 42.

The cash register 4 has an arithmetic logic unit such as a CPU (Central Processing Unit) and a memory unit in which a program is stored. For example, the cash register 4 realizes the processing units mentioned above by execution of the program stored in the memory unit by the arithmetic logic unit.

The optout information acceptance unit 41 accepts input of rejection information, which is information indicating that a customer does not want a feature value to be registered, in response to an operation by the customer. For example, the optout information acceptance unit 41 displays options indicating whether or not a customer allow registration of a feature value on a display device such as a touch panel included by the cash register 4. Then, the optout information acceptance unit 41 accepts the input of the rejection information when the customer selects an option indicating that the customer does not want the feature value to be registered. Thus, the optout information acceptance unit 41 accepts input of rejection information in response to some operation by a customer.

The transmission unit 42 transmits various information to the customer information registration apparatus 2. For example, when the optout information acceptance unit 41 accepts input of rejection information, the transmission unit 42 transmits the rejection information to the customer information registration apparatus 2. Moreover, for example, when a customer purchases a product, the transmission unit 42 can transmit information indicating that the customer has purchased the product to the customer information registration apparatus 2.

The customer terminal 5 is an information processing apparatus owned by a customer. The customer terminal 5 is, for example, a mobile terminal such as a smartphone or a tablet, or an information processing apparatus such as a personal computer.

FIG. 10 shows an example of components specific to this example embodiment among components included by the customer terminal 5. Referring to FIG. 10, the customer terminal 5 has, for example, an image data acquisition unit 51, an optout information acceptance unit 52, and a transmission unit 53.

The customer terminal 5 has an arithmetic logic unit such as a CPU (Central Processing Unit) and a memory unit in which a program is stored. For example, the customer terminal 5 realizes the abovementioned processing units by execution of the program stored in the memory unit by the arithmetic logic unit.

The image data acquisition unit 51 acquires image data of a face of a customer operating the customer terminal 5 by using a camera included by the customer terminal 5, for example.

The optout information acceptance unit 52 accepts input of rejection information, which is information indicating that a customer does not want a feature value to be registered, in response to an operation by the customer. For example, the optout information acceptance unit 52 displays options indicating whether or not a customer allows registration of a feature value on a display device included by the customer terminal 5. Then, the optout information acceptance unit 52 accepts the input of the rejection information when the customer selects an option indicating that the customer does not want the feature value to be registered. Thus, the optout information acceptance unit 52 accepts input of rejection information in response to some operation by a customer.

The transmission unit 53 transmits various information to the customer information registration apparatus 2. For example, when the optout information acceptance unit 52 accepts input of rejection information, the transmission unit 53 associates the rejection information with face data of a customer's face acquired by the image data acquisition unit 51 and transmits to the customer information registration apparatus 2.

The, customer terminal 5 may have a feature value calculation unit that calculates a feature value based on image data of a face acquired by the image data acquisition unit 51. In a case where the customer terminal 5 includes the feature value calculation unit, the transmission unit 53 can associate rejection information acquired by the optout information acceptance unit 52 with a feature value calculated by the feature value calculation unit and transmits to the customer information registration unit 2.

The example of the configuration of the customer information registration system 1 has been described above.

Next, an operation of the customer information registration apparatus 2 will be described. FIG. 11 is a flowchart showing an example of an operation until the customer information registration apparatus 2 stores a certain feature value calculated based on image data as the customer information 245 or performs deletion based on the optout information 244.

Referring to FIG. 11, the image data acquisition unit 251 acquires image data from the camera 3 via the communication I/F unit 23 (step S101). Then, the image data acquisition unit 251 stores the acquired image data as the image data information 241 into the storage unit 24.

The feature value calculation unit 252 calculates the feature value of a face image (step S102). For example, the feature value calculation unit 252 extracts a face image (a face region) that is a region indicating the face of a customer from the image data information 241. Then, the feature value calculation unit 252 calculates the feature value of the extracted face image. After that, the feature value calculation unit 252 stores the calculated feature value into the storage unit 24 as the temporary customer information 242 (step S103). In a case where the feature value calculated by the feature value calculation unit 252 is included by the optout information 244, the feature value calculation unit 252 does not need to store the feature value included by the optout information 244 into the storage unit 24.

In a case where the optout information acquisition unit 254 acquires rejection information and stores into the storage unit 24 as the optout information 244 (step S105, YES), the deletion unit 255 deletes the feature value according to the optout information 244 from the temporary customer information 242 (step S107).

On the other hand, in a case where the optout information acquisition unit 254 does not store the optout information (step S105, NO), the registration unit 256 confirms whether or not a predetermined interval has passed or it has become a predetermined time (step S105). In a case where the predetermined interval has passed or it has become the predetermined time (step S105, YES), the registration unit 256 acquires information included by the temporary customer information 242, and stores the acquired information into the storage unit 24 as the customer information 245 (step S106). Moreover, the registration unit 256 deletes the information included by the temporary customer information 242. On the other hand, in a case where the predetermined interval has not passed or it has not become the predetermined time (step S105, NO), the registration unit 256 does not perform the process of step S106. In this case, the operation returns to the process of step S104.

The example of the operation of the customer information registration apparatus 2 has been described above.

Thus, the customer information registration apparatus 2 has the optout information acquisition unit 254 and the deletion unit 255. With such a configuration, the customer information registration apparatus 2 can delete the temporary customer information 242 based on the optout information 244 acquired by the optout information acquisition unit 254, and update the ancillary information 243. Consequently, it is possible to prevent the feature value of a customer who does not want registration of a feature value from being stored, and delete information originating from and relating to the customer from statistical information that does not identify an individual customer. That is to say, with the above configuration, it becomes possible to delete the temporary customer information 242 directly relating to a customer in response to manifestation of an intention that a person does not want registration, and also update the ancillary information 243, which is indirect information. In other words, it becomes possible to more strictly respond to an individual's desire that he/she does not want personal information to be used.

In this example embodiment, a case of realizing the customer information registration apparatus 2 by one information processing apparatus has been described (see FIG. 2). However, the customer information registration apparatus 2 may be realized by a plurality of information processing apparatuses connected so as to be able to communicate via a network, for example.

Further, in this example embodiment, a case in which the camera 3 is provided outside the customer information registration apparatus 2 is illustrated. However, the customer information registration apparatus 2 may have a function as the camera 3. The camera 3 may have a function as the customer information registration apparatus 2. That is to say, the camera 3 may be configured to have the respective functions described in this example embodiment.

Further, in this example embodiment, the registration unit 256 executes processing so that a feature value for which information indicating that a customer does not want registration of the feature value is not acquired from the customer in a predetermined interval or by a predetermined time is managed as the customer information 245. However, the registration unit 256 may be configured to manage, as the customer information 245, only a feature value that the behavior of a customer in the shop indicated by behavior-related information satisfies a given condition among feature values that for which the optout information 244 is not stored in a predetermined interval or by a predetermined time. In other words, for example, the customer information registration apparatus 2 may include a condition determination unit, and the registration unit 256 may be configured to store a feature value into the storage unit 24 as the customer information 245 based on the result of condition determination by the condition determination unit. In this case, for example, the condition determination unit can be configured to determine whether or not to store the face data feature value into the storage unit based on whether or not the behavior of a customer in the shop is determined from behavior-related information to show that the customer intends to purchase a product or the customer has considered purchase of a product.

Further, the customer information registration system 1 may be configured to allow a customer to select ancillary information to delete. For example, in a case where the cash register 4 accepts optout information (rejection information), it is possible to display a list of ancillary information originating from a customer who wants to delete information on a display (not shown) installed at the cash register 4, and accept input of ancillary information which the customer wants to delete. Consequently, the customer information registration apparatus 2 can manage information based on a desire of each customer. The same applies to a case where the customer terminal 5 accepts optout information. Thus, the cash register 4 and the customer terminal 5 may be configured to accept input of ancillary information that a customer wants to delete, together with rejection information.

Further, the customer information registration system 1 may be configured to delete only ancillary information originating from a customer who wants deletion of information according to optout information. In other words, the customer information registration apparatus 2 can be configured to perform only update of the ancillary information 243 (do not perform deletion of the temporary customer information 242) based on the optout information 244. For example, it is assumed that there is a customer who wants deletion of information of a purchased product (purchase information) though does not want deletion of face data because the customer wants the shop to recognize as a repeater. In this case, face data and ancillary information are displayed as deletion target information on the display installed at the cash register 4. Then, when a customer selects and inputs purchase information from among the displayed deletion target information, only purchase information of information relating to the customer is deleted. With this, it is possible to manage information based on a desire of each customer. The same applies to a case where the customer terminal 5 accepts optout information. Thus, the customer information registration apparatus 2 may be configured to perform only update of the ancillary information 243 (configured not to perform deletion of the temporary customer information 242) based on the optout information 244.

### Second Example Embodiment

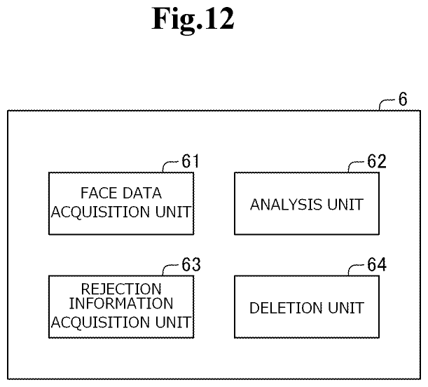

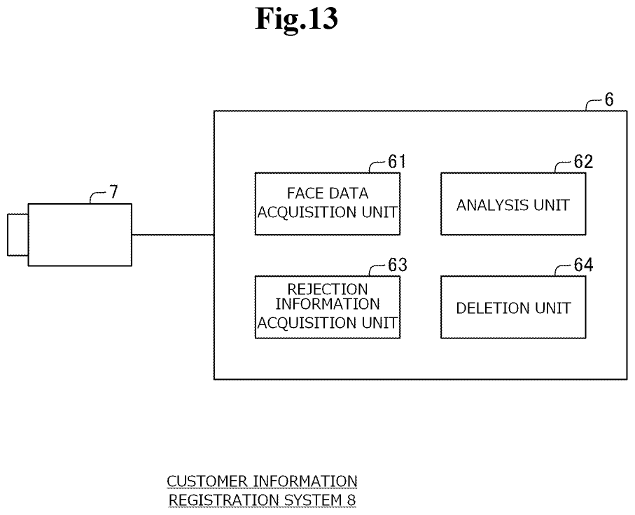

Next, with reference to FIGS. 12 and 13, a second example embodiment of the present invention will be described. In the second example embodiment, the overview of configurations of a customer information registration apparatus 6 and a customer information registration system 8 will be described.

First, with reference to FIG. 12, the customer information registration apparatus 6 will be described. FIG. 12 shows an example of the configuration of the customer information registration apparatus 6. Referring to FIG. 12, the customer information registration apparatus 6 has, for example, a face data acquisition unit 61, an analysis unit 62, a rejection information acquisition unit 63, and a deletion unit 64.

For example, the customer information registration apparatus 6 has an arithmetic logic unit such as a CPU and a memory unit in which a program is stored. The customer information registration apparatus 6 realizes the respective processing units mentioned above by execution of the program stored in the memory unit by the arithmetic logic unit.

The face data acquisition unit 61 acquires face data of a customer based on image data acquired by a camera of a shop and temporarily stores the acquired face data of the customer into a storage unit.

The analysis unit 62 acquires ancillary information, which is information that does not identify an individual customer in a shooting site of the camera. For example, the analysis unit 62 acquires ancillary information based on the image data acquired by the camera.

The rejection information acquisition unit 63 acquires rejection information indicating that registration of the face data of the customer is not wanted.

The deletion unit 64 deletes the face data of the customer temporarily stored in the storage unit in accordance with the rejection information acquired by the rejection information acquisition unit 63. Moreover, the deletion unit 64 deletes information originating from the deletion target customer from the ancillary information and updates the ancillary information in accordance with the rejection information.

Thus, the customer information registration apparatus 6 has the rejection information acquisition unit 63 and the deletion unit 64. With such a configuration, the customer information registration apparatus 6 can delete face data of a customer temporarily stored in the storage unit and also update ancillary information based on rejection information acquired by the rejection information acquisition unit 63. Consequently, it is possible to prevent face data of a customer who does not want registration of the face data from being stored, and it is also possible to delete information originating from and relating to the customer from ancillary information that does not identify an individual customer. That is to say, with the above configuration, it becomes possible to, in accordance with manifestation of an intention that a person does not want registration, delete face data directly relating to a customer and also update ancillary information, which is indirect information. In other words, it becomes possible to more strictly respond to an individual's desire that he/she does not want personal information to be used.

Further, the customer information registration apparatus 6 described above can be realized by installation of a given program into the customer information registration apparatus 6. To be specific, a program as another aspect of the present invention is a program for causing the customer information registration apparatus 6 having a storage unit to realize: the face data acquisition unit 61 that acquires face data of a customer based on image data acquired by a camera of a shop and temporarily stores the acquired face data of the customer into the storage unit; the analysis unit 62 that acquires ancillary information, which is information that does not identify an individual customer in a shooting site of the camera; the rejection information acquisition unit 63 that acquires rejection information indicating that registration of the face data of the customer is not wanted; and the deletion unit 64 that, in accordance with the rejection information acquired by the rejection information acquisition unit 63, deletes the face data of the customer temporarily stored in the storage unit, and also deletes information originating from the deletion target customer from the ancillary information and updates the ancillary information.

Further, a customer information registration method executed by the customer information registration apparatus 6 described above is a method by which the customer information registration apparatus 6 having a storage unit acquires face data of a customer based on image data acquired by a camera of a shop and temporarily stores the acquired face data of the customer into the storage unit, acquires ancillary information, which is information that does not identify an individual customer in a shooting site of the camera, acquires rejection information indicating that registration of the face data of the customer is not wanted and, in accordance with the acquired rejection information, deletes the face data of the customer temporarily stored in the storage unit and also deletes information originating from the deletion target customer from the ancillary information and updates the ancillary information.

Further, every kind of function included by the customer information registration apparatus 6 described above may be included by a camera. To be specific, a camera as another aspect of the present invention is a camera which has: the face data acquisition unit 61 that acquires face data of a customer based on acquired image data and temporarily stores the acquired face data of the customer into a storage unit; the analysis unit 62 that acquires ancillary information, which is information that does not identify an individual customer in a shooting site of the camera; the rejection information acquisition unit 63 that acquires rejection information indicating that registration of the face data of the customer is not wanted; and the deletion unit 64 that, in accordance with the rejection information acquired by the rejection information acquisition unit 63, deletes the face data of the customer temporarily stored in the storage unit, and also deletes information originating from the deletion target customer from the ancillary information and updates the ancillary information.

Further, as shown in FIG. 13, the customer information registration system 8 may have a camera 7 that acquires image data and the customer information registration apparatus 6. In the case shown in FIG. 13, the camera 7 and the customer information registration apparatus 6 are connected so as to be able to communicate with each other. The configuration of the customer information registration apparatus 6 shown in FIG. 13 is the same as already described using FIG. 12. Therefore, a detailed description thereof will be omitted.

The inventions of the program, the customer information registration method, the camera, and the customer information registration system that have the configurations described above have the same effects and actions as the customer information registration apparatus 6, and therefore, can achieve the abovementioned object of the present invention.

### <Supplementary Notes>

The whole or part of the example embodiments disclosed above can be described as the following supplementary notes. The overview of the customer information registration apparatus and so on according to the present invention will be described below. However, the present invention is not limited to the following configurations.

### (Supplementary Note 1)

A customer information registration apparatus comprising:

a face data acquisition unit configured to acquire face data of a customer based on image data acquired by a camera of a shop, and temporarily store the acquired face data of the customer into a storage unit;

an analysis unit configured to acquire ancillary information, which is information that does not identify an individual customer in a shooting site of the camera;

a rejection information acquisition unit configured to acquire rejection information indicating that registration of the face data of the customer is not wanted; and

a deletion unit configured to, in response to the rejection information acquired by the rejection information acquisition unit, delete the face data of the customer temporarily stored in the storage unit, and also delete information originating from the customer that is a deletion target from the ancillary information and update the ancillary information.

### (Supplementary Note 2)

The customer information registration apparatus according to Supplementary Note 1, wherein the rejection information acquisition unit is configured to acquire the rejection information indicating that registration of the face data of the customer is not wanted from an external device operated by the customer.

### (Supplementary Note 3)

The customer information registration apparatus according to Supplementary Note 1 or 2, wherein the rejection information acquisition unit is configured to, based on the image data, acquire the rejection information indicating that registration of the face data of the customer is not wanted.

### (Supplementary Note 4)

The customer information registration apparatus according to any one of Supplementary Notes 1 to 3, wherein:

the rejection information acquisition unit is configured to acquire the rejection information indicating that registration of the face data of the customer is not wanted from an external device operated by the customer, and also associate the acquired rejection information with the face data of the customer; and

the deletion unit is configured to delete the face data of the customer associated with the rejection information by the rejection information acquisition unit.

### (Supplementary Note 5)

The customer information registration apparatus according to any one of Supplementary Notes 1 to 4, wherein the deletion unit is configured to update the ancillary information so that there has been no customer who does not want registration, in response to the rejection information acquired by the rejection information acquisition unit.

### (Supplementary Note 6)

The customer information registration apparatus according to any one of Supplementary Notes 1 to 5, comprising a registration unit configured to register the temporarily stored face data of the customer at predetermined intervals or at a predetermined given time.

### (Supplementary Note 7)

The customer information registration apparatus according to any one of Supplementary Notes 1 to 6, wherein the face data acquisition unit is configured so as not to temporarily store the face data of the customer into the storage unit in response to the rejection information.

### (Supplementary Note 8)

The customer information registration apparatus according to any one of Supplementary Notes 1 to 7, wherein the face data acquisition unit is configured to temporarily store the acquired face data of the customer into a volatile memory included by the storage unit.

### (Supplementary Note 9)

The customer information registration apparatus according to any one of Supplementary Notes 1 to 8, comprising an output unit configured to perform given output according to a result of processing by the deletion unit.

### (Supplementary Note 10)

A customer information registration method executed by a customer information registration apparatus including a storage unit, the customer information registration method comprising:

acquiring face data of a customer based on image data acquired by a camera of a shop, and temporarily store the acquired face data of the customer into the storage unit;

acquiring ancillary information, which is information that does not identify an individual customer in a shooting site of the camera;

acquiring rejection information indicating that registration of the face data of the customer is not wanted; and

in response to the acquired rejection information, deleting the face data of the customer temporarily stored in the storage unit, and also deleting information originating from the customer that is a deletion target from the ancillary information and updating the ancillary information.

### (Supplementary Note 11)

A non-transitory computer-readable recording medium having a program recorded thereon, the program comprising instructions for causing a customer information registration apparatus including a storage unit to realize:

a face data acquisition unit configured to acquire face data of a customer based on image data acquired by a camera of a shop, and temporarily store the acquired face data of the customer into a storage unit;

an analysis unit configured to acquire ancillary information, which is information that does not identify an individual customer in a shooting site of the camera;

a rejection information acquisition unit configured to acquire rejection information indicating that registration of the face data of the customer is not wanted; and

a deletion unit configured to, in response to the rejection information acquired by the rejection information acquisition unit, delete the face data of the customer temporarily stored in the storage unit, and also delete information originating from the customer that is a deletion target from the ancillary information and update the ancillary information.

### (Supplementary Note 12)

A camera comprising:

a face data acquisition unit configured to acquire face data of a customer based on acquired image data, and temporarily store the acquired face data of the customer into a storage unit;

an analysis unit configured to acquire ancillary information, which is information that does not identify an individual customer in a shooting site;

a rejection information acquisition unit configured to acquire rejection information indicating that registration of the face data of the customer is not wanted; and

a deletion unit configured to, in response to the rejection information acquired by the rejection information acquisition unit, delete the face data of the customer temporarily stored in the storage unit, and also delete information originating from the customer that is a deletion target from the ancillary information and update the ancillary information.

### (Supplementary Note 13)

A customer information registration system comprising a customer information registration apparatus and a camera, wherein the customer information registration apparatus includes:

a face data acquisition unit configured to acquire face data of a customer based on image data acquired by a camera of a shop, and temporarily store the acquired face data of the customer into a storage unit;

an analysis unit configured to acquire ancillary information, which is information that does not identify an individual customer in a shooting site of the camera;

a rejection information acquisition unit configured to acquire rejection information indicating that registration of the face data of the customer is not wanted; and

a deletion unit configured to, in response to the rejection information acquired by the rejection information acquisition unit, delete the face data of the customer temporarily stored in the storage unit, and also delete information originating from the customer that is a deletion target from the ancillary information and update the ancillary information.

### (Supplementary Note 14)

A customer information registration apparatus comprising:

an analysis unit configured to acquire ancillary information, which is information that does not identify an individual customer in a shooting site of a camera of a shop;

a rejection information acquisition unit configured to acquire rejection information indicating that registration of the ancillary information relating to a customer is not wanted; and

a deletion unit configured to, in response to the rejection information acquired by the rejection information acquisition unit, delete information originating from the customer who does not want registration of the ancillary information from the ancillary information, and update the ancillary information.

The program described in the example embodiments and supplementary notes is stored in a memory unit, or recorded on a computer-readable recording medium. For example, the recording medium is a portable medium such as a flexible disk, an optical disk, a magnetooptical disk, and a semiconductor memory.

Although the present invention has been described above with reference to the example embodiments, the present invention is not limited to the example embodiments. The configurations and details of the present invention can be changed in various manners that can be understood by one skilled in the art within the scope of the present invention.

The present invention is based upon and claims the benefit of priority from Japanese patent application No. 2018-180214, filed on Sep. 26, 2018, the disclosure of which is incorporated herein in its entirety by reference.

### DESCRIPTION OF NUMERALS

1 customer information registration system
2 customer information registration apparatus
21 operation input unit
22 screen display unit
221 image information
222 visiting customer information
223 weather information
224 number-of-visits statistical information
225 attribute statistical information
226 conversion information
227 number-of-passing-persons information
23 communication I/F unit
24 storage unit
241 image data information
242 temporary customer information
243 ancillary information
244 optout information
245 customer information
246 program
arithmetic logic unit
251 image data acquisition unit
252 feature value calculation unit
253 analysis unit
254 optout information acquisition unit
255 deletion unit
256 registration unit
257 output unit
3 camera
4 cash register
41 optout information acceptance unit
42 transmission unit
5 customer terminal
51 51 image data acquisition unit
52 optout information acceptance unit
53 transmission unit
6 customer information registration apparatus
61 face data acquisition unit
62 analysis unit
63 rejection information acquisition unit
64 deletion unit
7 camera
8 customer information registration system

What is claimed is:

1. A customer information registration apparatus comprising:
at least one memory configured to store instructions; and
at least one hardware processor configured to execute the instructions to:
acquire face data of a customer based on image data acquired by a camera of a shop, and temporarily store the acquired face data of the customer into a storage unit;
acquire ancillary information, which is information that does not identify an individual customer in a shooting site of the camera;
acquire rejection information indicating that registration of the face data of the customer is not wanted; and
in response to the acquired rejection information, delete the face data of the customer temporarily stored in the storage unit, and also delete information originating from the customer that is a deletion target from the ancillary information and update the ancillary information.

2. The customer information registration apparatus according to claim 1, wherein the at least one hardware processor is configured to execute the instructions to acquire the rejection information indicating that registration of the face data of the customer is not wanted from an external device operated by the customer.

3. The customer information registration apparatus according to claim 1, wherein the at least one hardware processor is configured to execute the instructions to, based on the image data, acquire the rejection information indicating that registration of the face data of the customer is not wanted.

4. The customer information registration apparatus according to claim 1, wherein the at least one hardware processor is configured to execute the instructions to:
acquire the rejection information indicating that registration of the face data of the customer is not wanted from an external device operated by the customer, and also associate the acquired rejection information with the face data of the customer; and
delete the face data of the customer associated with the rejection information.

5. The customer information registration apparatus according to claim 1, wherein the at least one hardware processor is configured to execute the instructions to update the ancillary information so that there has been no customer who does not want registration, in response to the acquired rejection information.

6. The customer information registration apparatus according to claim 1, wherein the at least one hardware processor is configured to execute the instructions to register the temporarily stored face data of the customer at predetermined intervals or at a predetermined given time.

7. The customer information registration apparatus according to claim 1, wherein the at least one hardware processor is configured to execute the instructions so as not to temporarily store the face data of the customer into the storage unit in response to the rejection information.

8. The customer information registration apparatus according to claim 1, wherein the at least one hardware processor is configured to execute the instructions to temporarily store the acquired face data of the customer into a volatile memory included by the storage unit.

9. The customer information registration apparatus according to claim 1, wherein the at least one hardware processor is configured to execute the instructions to perform given output according to a result of deletion processing.

10. A customer information registration method executed by a customer information registration apparatus including a storage unit, the customer information registration method comprising:
acquiring face data of a customer based on image data acquired by a camera of a shop, and temporarily store the acquired face data of the customer into the storage unit;
acquiring ancillary information, which is information that does not identify an individual customer in a shooting site of the camera;
acquiring rejection information indicating that registration of the face data of the customer is not wanted; and
in response to the acquired rejection information, deleting the face data of the customer temporarily stored in the storage unit, and also deleting information originating from the customer that is a deletion target from the ancillary information and updating the ancillary information.

11. A non-transitory computer-readable recording medium having a program recorded thereon, the program comprising instructions for causing a customer information registration apparatus including a storage unit to realize:
a face data acquisition unit configured to acquire face data of a customer based on image data acquired by a camera of a shop, and temporarily store the acquired face data of the customer into a storage unit;
an analysis unit configured to acquire ancillary information, which is information that does not identify an individual customer in a shooting site of the camera;
a rejection information acquisition unit configured to acquire rejection information indicating that registration of the face data of the customer is not wanted; and
a deletion unit configured to, in response to the rejection information acquired by the rejection information acquisition unit, delete the face data of the customer temporarily stored in the storage unit, and also delete information originating from the customer that is a deletion target from the ancillary information and update the ancillary information.

12-14. (canceled)
